(19) United States
(12) Patent Application Publication
(10) Pub. No.: US 2008/0296141 A1
(43) Pub. Date: Dec. 4, 2008

(54) Key Input Apparatus and Electronic Device

(76) Inventors: Toshinobu Ogatsu, Minato-ku (JP); Yoshihide Saida, Kakegawa-shi (JP)

Correspondence Address: DICKSTEIN SHAPIRO LLP, 1177 AVENUE OF THE AMERICAS (6TH AVENUE), NEW YORK, NY, 10036-2714, US

(21) Appl. No.: 12/064,503

(22) PCT Filed: Aug. 23, 2006
(86) PCT No.: PCT/JP2006/316482

§ 371 Date: Mar. 24, 2008

(30) Foreign Application Priority Data
Aug. 25, 2005 (JP) 2005 244475

(51) Int. Cl. H01H 1/26

(52) U.S. Cl. 200/535

(57) ABSTRACT

An electrode is disposed on the upper surface of a printed circuit board, and a bowl-shaped metal dome is disposed so as to cover the electrode. An elastic, deformable push switch sheet is disposed on the metal dome. A convex section that protrudes downward is disposed in the push sheet in an area directly above the center portion of the metal dome. Formed in the area surrounding the convex section on the push switch sheet is a notch whereby the portion in which the convex section is formed is partitioned off in the form of a cantilever brace from the other portions of the push switch sheet. The notch is disposed outside of the portion that corresponds to the directly underlying area of the key top. The outside edge of the key top is thereby positioned inside the cantilever brace section in a plan view. In this manner, it is possible to reduce the required pressing force and obtain a good perception of key operation.

### TECHNICAL FIELD

The present invention relates to a key input apparatus mounted in a mobile phone or the like, and to an electronic device in which the key input apparatus is mounted.

### BACKGROUND ART

Recently, with the expansion of the mobile phone market, there is a need to appeal to users by making the mobile phones smaller and thinner. Consequently, there is also a need to make the key input apparatuses mounted in mobile phones thinner, while preserving the perception of a click. Technology has been developed for such a key input apparatus (e.g., see Patent Documents 1 and 2), in which an electrode is disposed on a circuit board, a bowl-shaped metallic component is disposed on the electrode, the metallic component is covered by an elastic sheet, and a key is disposed on the elastic sheet.

A conventional key input apparatus will be described below. FIG. 13 is a perspective view showing a conventional key input apparatus, and FIG. 14 is a partial cross-sectional view along the line C-C′ in FIG. 13. A printed circuit board 102 is disposed on a conventional key input apparatus 101, as shown in FIGS. 13 and 14. An electrical component 103 is mounted on one surface of the printed circuit board 102 on which a wiring pattern (not shown) is formed. An electrode 104 is locally disposed on the surface of the side of the printed circuit board 102 on which an electrical component 103 is not mounted. A saucer-shaped (bowl-shaped) metal dome 105 is disposed so as to cover the electrode 104. The metal dome 105 is formed from a thin metal plate and can be depressed by pressure applied to the top surface so that contact is made with the electrode 104. The electrode 104 and metal dome 105 constitute a contact part.

The metal dome 105 is disposed in a prescribed position on the printed circuit board 102 so that it is covered by a single-sided adhesive sheet 106. The single-sided adhesive sheet 106 is a thin sheet composed of PET (polyethylene terephthalate) or the like, and an adhesive is attached to the undersurface and bonded to the printed circuit board 102 and metal dome 105.

A push switch sheet 107 is disposed on the single-sided adhesive sheet 106. A downward-projecting convex section 107a is disposed in an area that corresponds to the area directly above the center of the metal dome 105 on the push switch sheet 107. A support section 107b that projects downward and makes contact with the single-sided adhesive sheet 106 is disposed in an area that sandwiches the area directly above the metal dome 105 in the push switch sheet 107. The support section 107b keeps at a prescribed value the distance between the single-sided adhesive sheet 106 and the portions other than the support section 107b of push switch sheet 107.

The area surrounding the convex section 107a on the push switch sheet 107 is provided with a notch 107c whereby the area having the convex section 107a is partitioned off in the form of a cantilever brace from the other parts of the push switch sheet 107. The section of the cantilever brace surrounded by the notch 107c, including the convex section 107a, is referred to as a cantilever brace section 107d. The shape of the notch 107c as viewed from a direction perpendicular (hereinafter referred to as “plan view”) to the surface of the printed circuit board 102 is a U shape. A very thin, elastic sheet 108 is disposed on the push switch sheet 107. A key top 108a is formed integrally with the sheet 108 on the upper surface side of the sheet 108.

When a user presses down on the key top 108a in such a conventional key input apparatus 101, the area in which the key top 108a is formed in the sheet 108 deforms downward, whereby the cantilever brace section 107d on the push switch sheet 107 flexes. As a result, when the convex section 107a presses down on the center portion of the metal dome 105 by way of the single-sided adhesive sheet 106, the metal dome 105 deforms and makes contact with the electrode 104. The metal dome 105 is thereby electrically connected to the electrode 104, and the contact point is closed.

Patent Document 1: Japanese Laid-open Patent Publication No. 11-250758

Patent Document 2: Japanese Laid-open Patent Publication No. 2003-283634

### DISCLOSURE OF THE INVENTION

### Problems the Invention is Intended to Solve

The prior arts described above, however, have the following problems. Ordinarily, a certain size is necessary in order to assure ease of operation because users operate the key top 108a with a finger. Further, a smaller metal dome 105 must be formed to make the key input apparatus 101 thinner, and, consequently, the convex section 107a of the push switch sheet 107 that makes contact with the center of the metal dome 105 is also small. For this reason, the notch 107c that partitions the convex section 107a in the form of a cantilever brace is also formed small in accordance with the size of the convex section 107a.

Therefore, the portion that flexes on the cantilever brace section 107d of the push switch sheet 107, i.e., the length D shown in FIG. 13, is short, and the repulsive force of the push switch sheet 107 will increase when the key top 108a is pressed and the cantilever brace section 107d flexes. Also, since the notch 107c is positioned on the inner side of the key top 108a in the plan view when the key top 108a is pressed, the outer portion of the notch 107c, i.e., the portion excluding the cantilever brace section 107d in the push switch sheet 107, is caused to deform because the key top 108a itself substantially does not deform. In this manner, extra pressure is required in order to cause the metal dome 105 to deform, and it is not possible to obtain an adequate perception of key operation because the repulsive force as such is considerable when the cantilever brace section 107d flexes and portions other than the cantilever brace section 107d undergo deformation as well.

The present invention was contrived in view of the foregoing problems, and an object thereof is to provide a key input apparatus and electronic device equipped therewith in which a perception of satisfactory key operation can be achieved by reducing the required pressing force.

### Means for Solving the Problem

The key input apparatus according to the present invention comprises a key top that is depressed from above, an elastic sheet disposed below the key top and formed from a softer material than said key top, a notch formed in the elastic sheet and whereby a portion that corresponds to a directly underlying area of the key top in the elastic sheet is partitioned off in the shape of a cantilever brace from other portions, and a contact part disposed below the portion that corresponds to the directly underlying area and closed by the key top being pressed, wherein the notch is disposed outside of the portion that corresponds to the directly underlying area.

Since a notch is disposed outside of the portion that corresponds to the directly underlying area of the key top in the elastic sheet in the present invention, the portions other than the portions partitioned off by the notch in the elastic sheet do not deform when the key top is pressed. Also, the flex length of the elastic sheet can be lengthened. For this reason, it is possible to reduce the pressure required to close the contact point and produce a good perception of key operation.

The electronic device according to the present invention is wherein the key input apparatus mounted therein. The electronic device may be a mobile phone.

### EFFECT OF THE INVENTION

In accordance with the present invention, the required pressing force can be reduced and a good perception of key operation can be obtained in a key input apparatus.

### BRIEF DESCRIPTION OF THE DRAWINGS

FIG. 1 is a perspective view showing the mobile phone according to a first embodiment of the present invention;

FIG. 2 is a cross-sectional view along the line A-A′ shown in FIG. 1;

FIG. 3 is a partial cross-sectional view showing the area R in FIG. 2;

FIG. 4 is a perspective view showing the key input apparatus according to the present embodiment;

FIG. 5 is a partial top view of FIG. 4;

FIG. 6 is a partial cross-sectional view showing a state in which the key top has been depressed in the key input apparatus according to the present embodiment;

FIG. 7 is a partial top view showing the key input apparatus according to a second embodiment of the present invention;

FIG. 8 is a partial top view showing the key input apparatus according to a third embodiment of the present invention;

FIG. 9 is a partial top view showing the key input apparatus according to a fourth embodiment of the present invention;

FIG. 10 is a partial top view showing the key input apparatus according to a fifth embodiment of the present invention;

FIG. 11 is a partial top view showing the key input apparatus according to a sixth embodiment of the present invention;

FIG. 12 is a partial top view showing the key input apparatus according to a seventh embodiment of the present invention;

FIG. 13 is a perspective view showing a conventional key input apparatus; and

FIG. 14 is a partial cross-sectional view along the line C-C′ in FIG. 13.

### KEY

1: upper case
1a: flange
2: lower case
2a: support column section
3: LCD panel,
4: key input apparatus
5: printed circuit board
6: electrical component
7: electrode
8: metal dome
9: single-sided adhesive sheet
10, 20, 30, 40, 50, 60, 70: push switch sheets
10a, 20a, 30a, 40a, 50a, 60a, 70a: convex sections
10b: support section
10c, 20c, 30c, 40c, 50c, 60c, 70c: notches
10d, 20d, 30d, 40d, 50d, 60d, 70d: cantilever brace sections
11: sheet
12, 42, 52, 62, 72: key top
100: mobile phone
101: key input apparatus
102: printed circuit board
103: electrical component
104: electrode
105: metal dome
106: single-sided adhesive sheet
107: push switch sheet
107a: convex section
107b: support section
107c: notch
107d: cantilever brace section
108: sheet
108a: key top
B, D: distances.
R: area
W: width

### BEST MODE FOR CARRYING OUT THE INVENTION

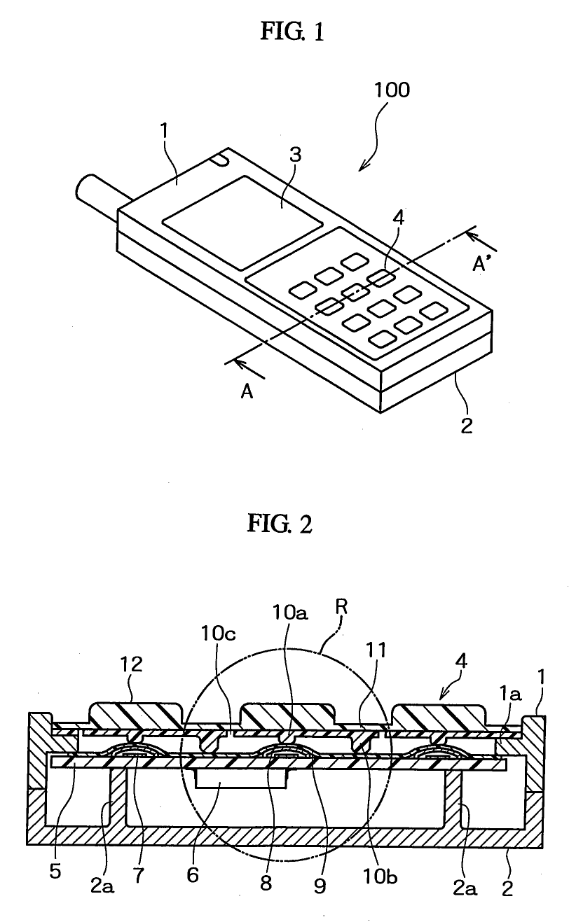

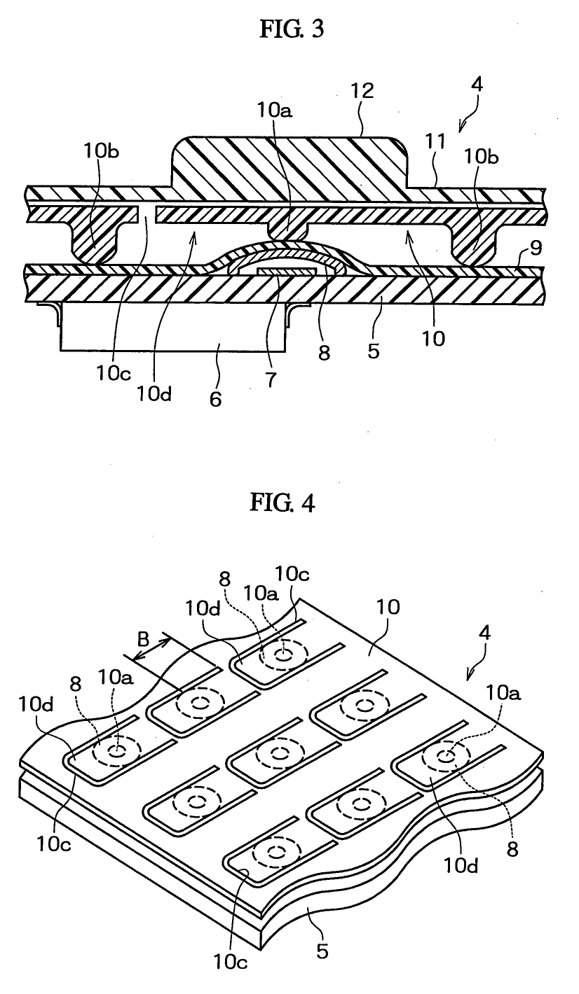

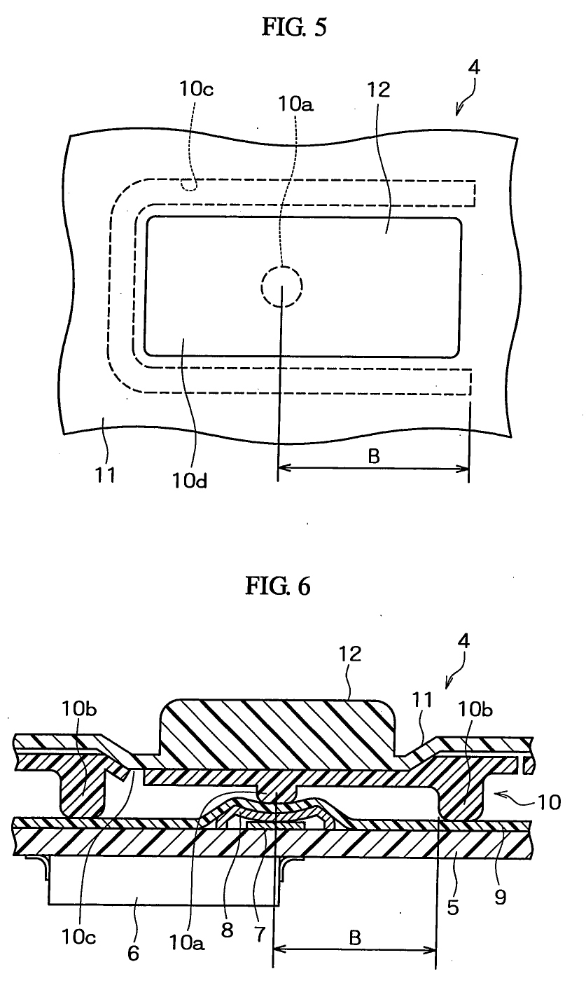

Hereinafter, embodiments of the present invention are described in detail with reference to the appended drawings. A first embodiment of the present invention is described first. FIG. 1 is a perspective view showing a mobile phone related to the first embodiment. FIG. 2 is a cross-sectional view along the line A-A′ shown in FIG. 1. FIG. 3 is a partial cross-sectional view showing the area R in FIG. 2. FIG. 4 is a perspective view showing the key input apparatus according to the present embodiment. FIG. 5 is a partial top view of FIG. 4. In FIG. 4, only the printed circuit board and push switch sheet are shown in order to simplify the diagram.

As shown in FIG. 1, an upper case 1 and a lower case 2, each of which are formed out of metal, alloy, plastic, or the like, are provided to the mobile phone 100 as an electronic device according to the present embodiment. The casing of the mobile phone 100 is formed by mutually connecting the upper case 1 and the lower case 2. A user interface section provided with an LCD panel 3 and key input apparatus 4 is disposed in the upper case 1. The arrangement of the LCD panel 3 and key input apparatus 4 is not limited to the arrangement shown in FIG. 1 and may be disposed for the convenience of the user.

As shown in FIGS. 2 to 5, a plurality of support column sections 2a is erectly disposed inside the lower case 2, facing the upper case 1, and a flange 1a is formed extending toward the interior on the inner surface of the upper case 1. A printed circuit board 5 is held between the support column sections 2a and the flange 1a. In other words, the distal end of the support column sections 2a is in contact with the lower surface of the printed circuit board 5, and the lower surface of the flange 1a is in contact with the peripheral area of the upper surface of the printed circuit board.

An electronic device 6 is mounted and wiring (not shown) is patterned and formed on the lower surface of the printed circuit board 5. Further, a plurality of electrodes 7 is disposed on the upper surface of the printed circuit board 5, and a plurality of saucer-shaped (bowl-shaped) metal domes 8 is provided so as to cover each of the electrodes 7. The metal domes 8 are formed from thin metal plates and are disposed so as to be convex on the upper side. The electrodes 7 are located inside the metal domes. The metal domes 8 are isolated from the electrodes 7 and do not to make contact with the electrodes when the domes are not depressed. The center of the metal domes recesses downward when pressure is applied from above so as to come into contact with the electrodes 7. A contact part is composed of an electrode 7 and a metal dome 8.

The entire upper surface of the printed circuit board 5 is covered by a single-sided adhesive sheet 9. The single-sided adhesive sheet 9 is a thin sheet composed of PET or the like. An adhesive is applied to the lower surface of the adhesive sheet and is bonded to the printed circuit board 5 and the metal domes 8. In this manner, the metal domes 8 are secured in prescribed locations on the printed circuit board 5.

An elastic, deformable push switch sheet 10 is disposed on the single-sided adhesive sheet 9. The push switch sheet 10 is composed of PET, for example, and has a thickness of 0.1 mm or less, but the materials and thickness of the push switch sheet 10 are not limited thereby. Convex sections 10a that protrude downward are disposed in the area on the push switch sheet that corresponds with the area directly above the center portion of the metal domes 8. Support sections 10b that protrude downward and make contact with the single-sided adhesive sheet 9 are disposed on the push switch sheet in the area that sandwiches the area directly above the metal domes 8. The convex sections 10a and support sections 10b are composed of, e.g., a hard plastic, and are integrally formed with the main body of the push switch sheet 10. The support sections 10b keep the distance between the sections other than the support section 10b of the push switch sheet 10 and the single-sided adhesive sheet 9 at a prescribed value.

The area surrounding the convex section 10a on the push switch sheet 10 is provided with a notch 10c whereby the portion in which the convex section 10a is formed is partitioned off in the form of a cantilever brace from the other portions of the push switch sheet 10. The cantilever brace portion including the convex section 10a and surrounded by the notch 10c is referred to as a “cantilever brace section 10d.” When viewed from the perpendicular direction to the surface of the printed circuit board 5, i.e., in a plan view, the shape of the cantilever brace section 10d is rectangular and the shape of the notch 10c is an inverted C-shape. One end section in the lengthwise direction of the cantilever brace section 10d is thereby connected to and supported by the portions of the push switch sheet other than the cantilever brace section 10d.

A very thin, flexible sheet 11 is disposed on the push switch sheet 10. The sheet 11 is composed of PET, for example, and has a thickness of 0.1 mm or less, but the material and thickness of the push switch sheet 10 is not limited thereby. A key top 12 composed of a hard plastic is mounted on the upper surface side of the sheet 11. The key top 12 is, for example, integrally formed with the sheet 11. The materials that form the sheet 11 and the push switch sheet 10 are both softer than the material that forms the key top 12. The notch 10c formed by the push switch sheet 10 is disposed outside of the portion that corresponds with the directly underlying area of the key top 12. More specifically, in a plan view, the outside periphery of the key top 12 is positioned inside the cantilever brace section 10d.

A single metal dome 8, cantilever brace section 10d, and key top 12 are provided for each electrode 7. For example, since there are 12 key tops 12 provided to the key input apparatus 4 of the mobile phone 100, there are also 12 cantilever brace sections 10d, metal domes 8, and electrodes 7, as shown in FIG. 1.

An adhesive material (not shown) having a prescribed width, e.g., double-sided tape, is applied to the entire external periphery of the upper surface of the push switch sheet 10, which is bonded to the sheet 11 via the adhesive material. The entire external periphery of the lower surface of the push switch sheet 10 is bonded to the upper surface of the flange 1a on the upper case 1. As a result, the key input apparatus 4 is sealed by the upper case 1 and the sheet 11, and dust, moisture, and the like do not enter the casing of the mobile phone 100.

The operation of the present embodiment will be described next. FIG. 6 is a partial cross-sectional view showing a state in which a key top has been depressed on the key input apparatus according to the present embodiment. When a user presses the key top 12 downward from above in the key input apparatus 4 shown in FIG. 3, the sheet 11 deforms and the key top 12 is displaced downward in the manner shown in FIG. 6. The cantilever brace section 10d of the push switch sheet 10 flexes at the base portion acting as a fulcrum in accompaniment with the displacement of the key top 12, and the convex section 10a is displaced downward. As a result, the convex section 10a presses down on the center portion of the metal dome 8 by way of the single-sided adhesive sheet 9. The metal dome 8 thereby deforms and makes contact with the electrode 7. As a result, the metal dome 8 is electrically connected to the electrode 7, and the contact point is closed.

In a plan view, the notch 10c of the push switch sheet 10 is disposed outside of the outer edge of the key top 12 at this time. Consequently, only the cantilever brace section 10d disposed directly beneath the key top 12 flexes when the key top 12 is depressed, and the other portions of the push switch sheet 10 do not deform substantially because the key top 12 is positioned inside the cantilever brace section 10d. Also, the distance that the portions in the cantilever brace section 10d flex at this time is equal to the distance from the base of the cantilever brace section 10d to the center of the convex section 10a, i.e., the distance B shown in FIG. 5.

The effect of the present embodiment will be described next. As described above in the present embodiment, only the cantilever brace section disposed directly beneath the key top 12 flexes when the key top 12 is depressed, and the other portions of the push switch sheet 10 do not deform. For this reason, extra pressure is not required to cause the other portions of the push switch sheet 10 to deform, and the downward pressure applied to the key top 12 is effectively and smoothly transmitted to the corresponding metal dome 8.

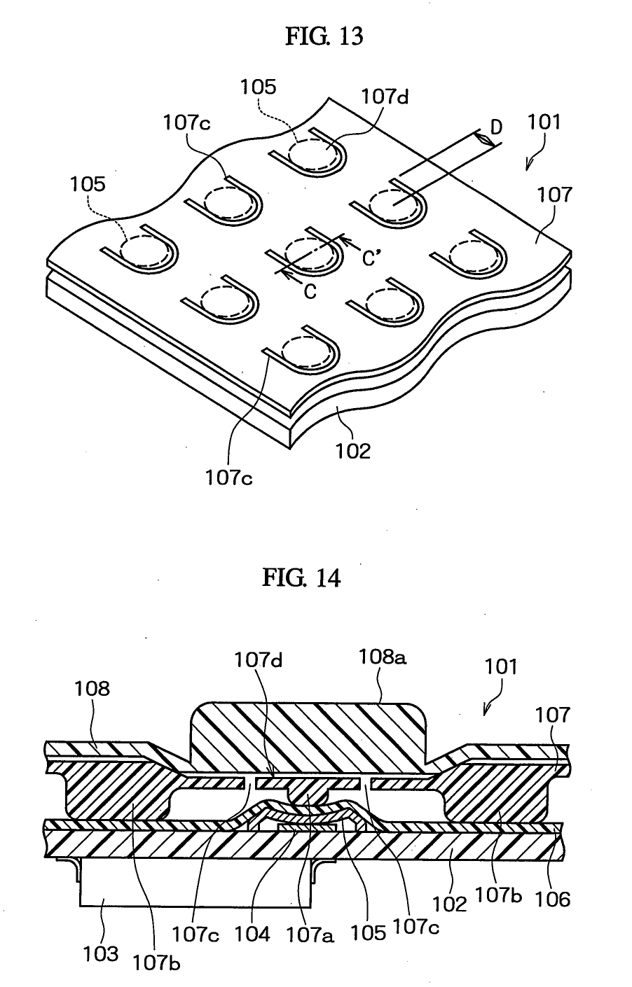

Further, a notch 10c is formed outside the outer edge of the key top 12, whereby it is possible to set the flexing distance B shown in FIG. 5 to be greater than the flexing distance D (see FIG. 13) in a conventional key input apparatus. For this reason, the repulsive force applied by the push switch sheet 10 is reduced, and the cantilever brace section flexes more readily when the cantilever brace section 10d is flexed. In this manner, it is possible to obtain an adequate perception of key operation (key-click and key-input perception) because the pressure required to close the contact point is reduced in the key input apparatus 4 according to the present embodiment.

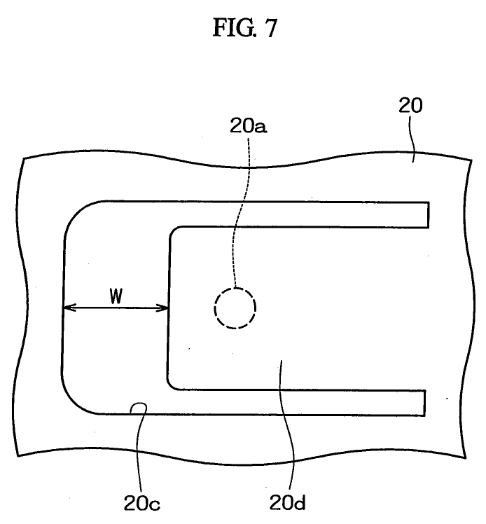

A second embodiment of the present invention will be described next. FIG. 7 is a partial top view showing the key input apparatus according to the present embodiment. Only the push switch sheet is shown in FIG. 7 to simplify the diagram. As shown in FIG. 7, the cantilever brace section 20d is shorter and the width of the notch 20c positioned on the distal end side of the cantilever brace section 20d is greater in the push switch sheet 20 in the present embodiment. The cantilever brace section 20d can thereby be made more flexible and the perception of key operation can be improved. The convex section 20a disposed above the center portion of the metal dome is positioned on the distal end portion of the cantilever brace section 20d. The composition, operation, and effect of the present embodiment other than those described above are the same as those of the first embodiment.

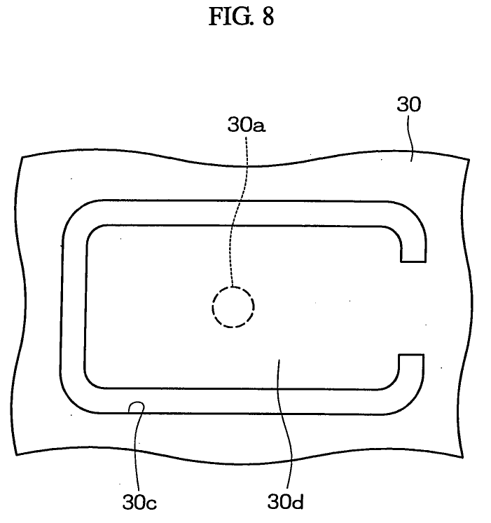

Next, a third embodiment of the present invention will be described. FIG. 8 is a partial top view showing the key input apparatus according to the present embodiment. As shown in FIG. 8, the width of the base portion is narrowed by making the notch 30c go around the base portion of the cantilever brace section 30d on the push switch sheet 30, and the two ends of the notch extend to a midway point in a mutually approaching direction. The cantilever brace section 30d is thereby made even easier to flex and the perception of key operation can be improved. The composition, operation, and effect of the present embodiment other than those described above in the present embodiment are the same as those of the first embodiment.

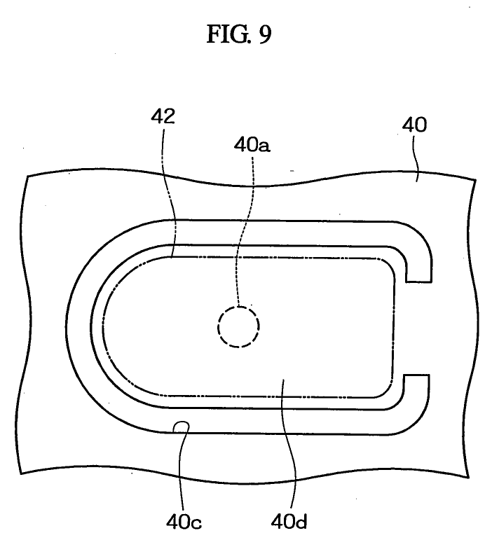

Next, a fourth embodiment of the present invention will be described. FIG. 9 is a partial top view showing the key input apparatus according to the present embodiment. The shape of the key top 12 shown in the first embodiment described above is rectangular, but a key top 42 in the shape of a U rounded at one end in the lengthwise direction is provided as a key top in the present embodiment, as shown in FIG. 9. In a plan view, the notch 40c formed on the push switch sheet 40 is formed in the shape of a U along the outer edge of the key top 42, and the two ends of the notch extend to a midway point in a mutually approaching direction. The design characteristics of mobile phones can thereby be enhanced, the cantilever brace section 40d can be made even easier to flex, and the perception of key operation can be improved. The composition, operation, and effect of the present embodiment other than those described above in the present embodiment are the same as those of the first embodiment.

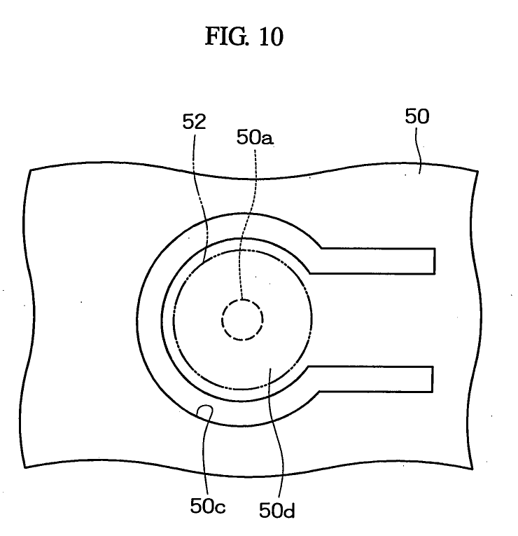

Next, a fifth embodiment of the present invention will be described. FIG. 10 is a partial top view showing the key input apparatus according to the present embodiment. As shown in FIG. 10, a circular key top 52 is provided as the key top in the present embodiment. In a plan view, the notch 50c formed in the push switch sheet 50 is annularly formed along the outer edge of the key top 52, and the two ends of the notch bend outward and extend in mutually parallel directions so as to avoid mutual contact. At this time the convex section 50a of the push switch sheet 50 is disposed in the center of the circular cantilever brace section 50d. The design characteristics of mobile phones can thereby be enhanced, the cantilever brace section 50d of the push switch sheet 50 can be made even easier to flex, and the perception of key operation can be improved. The composition, operation, and effect of the present embodiment other than those described above in the present embodiment are the same as those of the first embodiment.

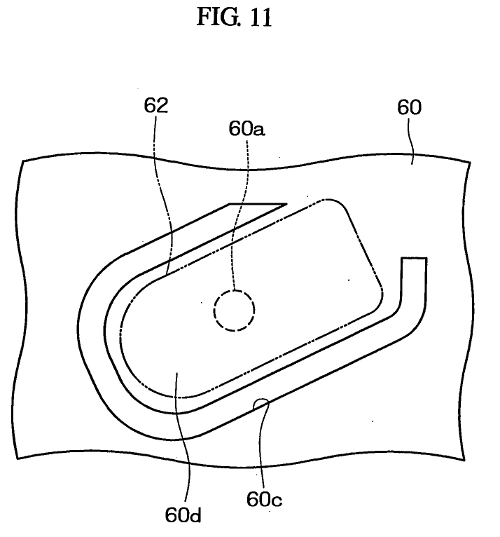

Next, a sixth embodiment of the present invention will be described. FIG. 11 is a partial top view showing the key input apparatus according to the present embodiment. As shown in FIG. 11, a key top 62 provided as the key top in the present embodiment is one in which the lengthwise direction of the key top is inclined in relation to the array direction of the key top, and one end in the lengthwise direction of the key top is a rounded, diagonally disposed U-shape. In a plan view, the notch 60c formed in the push switch sheet 60 is formed in the shape of a U along the outer edge of the key top 62. The design characteristics of mobile phones can thereby be enhanced, the cantilever brace section 60d of the push switch sheet 60 can be made even easier to flex, and the perception of key operation can be improved. The composition, operation, and effect of the present embodiment other than those described above in the present embodiment are the same as those of the first embodiment.

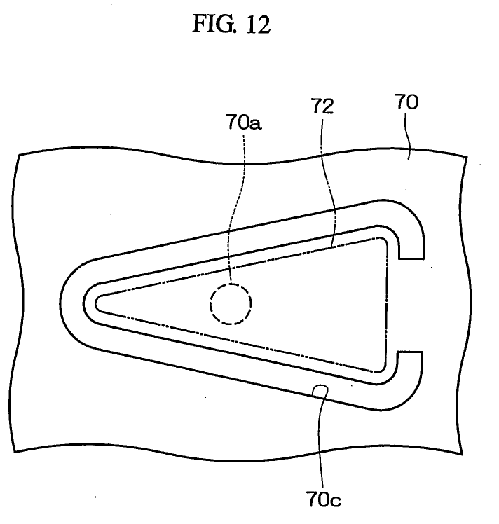

Next, a seventh embodiment of the present invention will be described. FIG. 12 is a partial top view showing the key input apparatus according to the present embodiment. As shown in FIG. 12, a triangular key top 72 that is thicker at the base section and narrows toward the distal end is provided as the key top in the present embodiment. In a plan view, a notch 70c formed in the push switch sheet 70 is formed in the shape of a triangle along the outer edge of the key top 72, and the two ends of the notch extend to a midway point in the mutually approaching direction. The design characteristics of mobile phones can thereby be enhanced, the cantilever brace section 70d of the push switch sheet 70 can be made even easier to flex, and the perception of key operation can be improved. The composition, operation, and effect of the present embodiment other than those described above in the present embodiment are the same as those of the first embodiment.

A mobile phone is used in the first embodiment described above as an example of the electronic device in which the key input apparatus according to the present invention is mounted, but the electronic device according to the present invention is not limited to mobile phones and may be applied to any electronic device. However, the key input apparatus according to the present invention is advantageously applied to small electronic devices because there is an advantage in that a good perception of key operation can be achieved even when the key input apparatus is made thinner.

### INDUSTRIAL APPLICABILITY

The key input apparatus of the present invention is suitable for mounting in mobile phones or other electronic devices.

1. A key input apparatus comprising:
a key top that is depressed from above;
an elastic sheet disposed below the key top and formed from a softer material than said key top;
a notch formed in said elastic sheet and whereby a portion that corresponds to a directly underlying area of said key top in said elastic sheet is partitioned off in the shape of a cantilever brace from other portions; and
a contact part disposed below the portion that corresponds to said directly underlying area and closed by said key top being pressed, wherein said notch is disposed outside of the portion that corresponds to said directly underlying area.

2. The key input apparatus according to claim 1, wherein said notch is formed so as to follow the outer edge of said key top when viewed from a direction perpendicular to the surface of said key top.

3. The key input apparatus according to claim 2, wherein a shape of said key top is rectangular, U-shaped, circular, or triangular when viewed from a direction perpendicular to the surface of said key top.

4. An electronic device characterized in having the key input apparatus mounted therein.

5. The electronic device according to claim 4, characterized in being a mobile phone.
